(19) United States
(12) Patent Application Publication
(10) Pub. No.: US 2026/0008206 A1
(43) Pub. Date: Jan. 8, 2026

(54) USE OF AND METHOD FOR SEPARATING INJECTION-MOLDING PART/ADHESIVELY BONDED PART BY USING NANO BUBBLE SOLUTION

(71) Applicant: East China University Of Science And Technology, Shanghai (CN)

(72) Inventors: Shuai Gu, Shanghai (CN); Penglin Wang, Shanghai (CN); Jianguo Yu, Shanghai (CN); Xuanyi Tang, Shanghai (CN)

(21) Appl. No.: 18/828,358

(22) Filed: Sep. 9, 2024

(30) Foreign Application Priority Data
Jul. 2, 2024 (CN) 2024108791781

(51) Int. Cl. B29B 17/02

(52) U.S. Cl. CPC B29B 17/02; B29B 2017/0248

(57) ABSTRACT

One disclosed method involves separating an injection-molding part/an adhesively bonded part by using a nanobubble solution by immersing a device to be treated in a nanobubble solution while heating and stirring, wherein the device to be treated and the nanobubble solution are oppositely charged, an absolute value of the Zeta potential of the nanobubble solution is greater than or equal to 25 mV, and an average particle size of nanobubbles in the nanobubble solution is less than or equal to 200 nm. The use of a nanobubble solution for recycling waste electronic equipment is also disclosed. Compared with a traditional recovery method, some examples of the disclosed method for separating an injection-molding part/an adhesively bonded part only need energy, water, and air, can treat a series of waste electronic products of different types in batches, and can realize effective plastic removal and debonding of a substrate in a green and efficient manner.

### CROSS REFERENCE TO RELATED APPLICATIONS

This application claims priority under 35 U.S.C. § 119(a) to Application No. 2024108791781, entitled USE OF AND METHOD FOR SEPARATING INJECTION-MOLDING PART/ADHESIVELY BONDED PART BY USING NANO BUBBLE SOLUTION, which was filed with the China National Intellectual Property Administration on Jul. 2, 2024, the entire contents of which are incorporated herein by reference for all purposes.

### TECHNICAL FIELD

The present disclosure relates to the technical field of post-treatment of waste electronic equipment and particularly relates to the use of and a method for separating an injection-molding part/an adhesively bonded part by using a nanobubble solution.

### BACKGROUND

With the popularization of electronic products and the increasing speed of updating, a large amount of waste electronic equipment is generated, which causes a series of problems with environmental protection and resource management. Meanwhile, the waste electronic equipment contains abundant resources including metals, precious metals, plastics, glass, and rare elements. The resources can be reprocessed for producing new electronic products or have other industrial applications. In order to achieve lightness, thinness, and water resistance of the electronic products, a large amount of injection-molding parts and adhesively bonded parts are used in the electronic products. These connecting modes bring a series of problems for the post-treatment of electronic products. Firstly, since plastics can affect a melting process, metal-containing the injection-molding parts cannot be directly recycled. Secondly, it is difficult to remove the injection-molding parts, and volatile nonpolar/polar solvents are generally used, which poses a potential threat to the environment.

Aiming at the difficulty of separating the injection-molding parts and adhesively bonded parts in the waste electronic equipment at the present stage, it is urgently needed to develop an economical, efficient, green, and strongly universal process.

### SUMMARY

An objective of the present disclosure is to provide use of and a method for separating an injection-molding part/an adhesively bonded part by using a nanobubble solution. Compared with the traditional recovery method, examples of the disclosed techniques only need energy, water, and air, and are capable of treating a series of waste electronic products of different types in batches, and can realize effective plastic removal and debonding of a substrate in a green and efficient manner.

To resolve the above technical problems, the disclosure provides the following technical solutions.

In the first aspect, the disclosure provides the use of a nanobubble solution for separating an injection-molding part/an adhesively bonded part.

The term “nanobubble solution” used herein refers to a liquid system incorporated with nanobubbles. The liquid system comprises a water solution and an aqueous solution.

In some illustrative examples of the disclosed techniques, the average particle size of the nanobubbles in the nanobubble solution is less than or equal to 200 nm, such as less than or equal to 150 nm, less than or equal to 100 nm, or less than or equal to 50 nm; such as 1 nm to 50 nm, 1 nm to 40 nm, 1 nm to 30 nm, 3 nm to 30 nm, 5 nm to 30 nm, 8 nm to 30 nm, 10 nm to 30 nm, 10 nm to 25 nm, 10 nm to 20 nm, about 10 nm, about 11 nm, about 12 nm, about 13 nm, about 14 nm, about 15 nm, about 16 nm, about 17 nm, about 18 nm, about 19 nm, or about 20 nm, but is not limited to the listed values. Other non-listed values or ranges within the value range are equally applicable.

The term “average particle size” used herein refers to the D50 particle size of the nanobubbles, i.e., the particle size corresponding to the cumulative particle size distribution percent of the nanobubbles in the solution reaching 50%. Its physical meaning is that the percent of the bubbles with the particle size greater than the D50 particle size accounts for 50% and the percent of the bubbles with the particle size less than the D50 particle size also accounts for 50%. D50 is also referred to as the median diameter or median particle diameter and is commonly used to indicate the average particle size of powders.

In some illustrative examples of the disclosed techniques, an absolute value of the Zeta potential of the nanobubble solution is greater than or equal to 25 mV, such as greater than or equal to 30 mV, greater than or equal to 40 mV, greater than or equal to 50 mV, or greater than or equal to 60 mV. Optionally, the absolute value of the Zeta potential of the nanobubble solution is between 25 mV and 100 mV, preferably between 30 mV and 100 mV, between 30 mV and 80 mV, or between 40 mV and 80 mV. As an example, the absolute value of the Zeta potential of the nanobubble solution may be about 40 mV, 41 mV, 42 mV, 43 mV, 44 mV, 45 mV, 46 mV, 47 mV, 48 mV, 49 mV, 50 mV, 51 mV, 52 mV, 53 mV, 54 mV, 55 mV, 56 mV, 57 mV, 58 mV, 59 mV, 60 mV, 61 mV, 62 mV, 63 mV, 64 mV, 65 mV, 66 mV, 67 mV, 68 mV, 69 mV, 70 mV, 71 mV, 72 mV, 73 mV, 74 mV, 75 mV, 76 mV, 77 mV, 78 mV, 79 mV, 80 mV, but is not limited to the listed values. Other non-listed values or ranges within the value range are equally applicable.

The term “Zeta potential” used herein refers to the potential of the shearing surface, also known as the electromotive potential (ζ-potential). The higher absolute value (positive or negative) of the Zeta potential indicates a more stable system, i.e. dissolution or dispersion against aggregation. Conversely, the lower absolute value (positive or negative) of the Zeta potential indicates the tendency to agglomeration or coagulation.

In some implementations, the nanobubble solution may be prepared by various methods, for example, in some illustrative examples of the disclosed techniques, the nanobubble solution may be prepared by mechanical stirring, acoustic vibration, electrolysis, atomization, hydrodynamic cavitation, and optical cavitation. The time for treating liquid using the bubble-producing method may be at least 30 s, preferably 30 seconds to 60 minutes, such as 1 minute to 60 minutes, 1 minute to 55 minutes, 1 minute to 50 minutes, 1 minute to 45 minutes, 1 minute to 40 minutes, 1 minute to 35 minutes, 1 minute to 30 minutes, 2 minutes to 30 minutes, 3 minutes to 30 minutes, 4 minutes to 30 minutes, or 5 minutes to 30 minutes.

In some implementations, the bubble-producing method may include mechanical stirring. During high-speed stirring, the shear force helps to create smaller and more uniform nanobubbles. The faster stirring speed contributes to the nanobubbles with the smaller particle size; conversely, the slower stirring speed contributes to the nanobubbles with the larger particle size. Therefore, the particle size of the nanobubbles can be regulated and controlled by adjusting the stirring speed. The method is described in detail in Chinese patent CN117339411A, the entire contents of which is incorporated herein by reference.

In some implementations, when the nanobubbles are produced by mechanical stirring, a stirring device may be arranged in a container for stirring liquid (for example water). In particular, the stirring speed of the stirring device may be 100 rpm to 10,000 rpm, such as about 200 rpm, about 300 rpm, about 400 rpm, about 500 rpm, about 600 rpm, about 700 rpm, about 800 rpm, about 900 rpm, about 1,000 rpm, about 2,000 rpm, about 3,000 rpm, about 4,000 rpm, about 5,000 rpm, about 6,000 rpm, about 7,000 rpm, about 8,000 rpm, about 9,000 rpm, but is not limited to the listed values. Other non-listed values or ranges within the value range are equally applicable. Through rapid mechanical stirring, the nanobubbles enter and are stably present in a solution system.

In some implementations, a concentration of the nanobubbles contained in the nanobubble solution may be at least about 1.0×10¹⁰ nanobubbles/mL, for example, the concentration of the nanobubbles contained in the nanobubble solution may be about 1.0×10¹⁰ nanobubbles/mL to about 1.0×1011 nanobubbles/mL, for example, 5.0×10¹⁰ nanobubbles/mL to about 1.0×10¹¹ nanobubbles/mL.

In some illustrative examples of the disclosed techniques, gas in the nanobubbles may be a single gas component and may also be a mixed gas consisting of several gas components. As an exemplary embodiment, the gas in the nanobubbles may include one or more of air, nitrogen (N₂), oxygen (O₂), carbon dioxide (CO₂), ozone (O₃), nitric oxide (NO), nitrogen dioxide (NO₂), helium (He), neon (Ne), argon (Ar). In some implementations, the gas in the nanobubbles may comprise oxygen. In some implementations, the gas in the nanobubbles may be oxygen. In other implementations, the gas in the nanobubbles may contain oxygen and other gases, for example, air.

In some implementations, the Zeta potential of the nanobubble solution may be regulated and controlled by various known methods, for example, in some exemplary examples, the Zeta potential of the nanobubble solution may be changed by adjusting the pH of the liquid, adding a specific electrolyte to the liquid during the production of the nanobubbles. For instance, in some example implementations, a nanobubble solution with a positive Zeta potential can be obtained by adding a certain amount of a cationic surfactant to the liquid. In some other examples, a nanobubble solution with a negative Zeta potential can be obtained by adding a certain amount of an anionic surfactant to the liquid.

In a second aspect, the present disclosure further provides the use of the nanobubble solution in recycling waste electronic equipment.

A large amount of injection-molding parts, adhesively bonded parts and other parts are used in the waste electronic equipment. It is difficult to separate the injection-molding parts, the adhesively bonded parts from metal parts, screens, and other recyclable parts by using a common treatment method. On the basis of the characteristic that the nanobubble solution can efficiently separate injection-molding parts/adhesively bonded parts when the nanobubble solution is used in recycling the waste electronic equipment, it can realize efficient plastic removal and debonding of recyclable parts in the waste electronic equipment.

In a third aspect, the present disclosure further provides a method for separating an injection-molding part/an adhesively bonded part by using a nanobubble solution, comprising: immersing a device to be treated in the nanobubble solution while heating and stirring, the device to be treated and the nanobubble solution are oppositely charged, the absolute value of the Zeta potential of the nanobubble solution is greater than or equal to 25 mV, and the average particle size of nanobubbles in the nanobubble solution is less than or equal to 200 nm.

In some implementations, the device to be treated may be any device containing injection-molding parts and/or adhesively bonded parts, preferably waste electronic equipment. In some illustrative examples of the disclosed techniques, the waste electronic equipment may be a computer, a mobile phone, a tablet, an earphone, or an electronic watch.

The nanobubbles have many excellent characteristics, such as long retention time in a solution, high mass transfer efficiency, and large specific surface area. The characteristics enable the nanobubbles to have wide application prospects in various fields. In some implementations, the nanobubble solution is creatively used in the recovery treatment of waste electronic equipment. The unique characteristics of the nanobubbles play a critical role in the separation of the injection-molding parts and/or adhesively bonded parts from a substrate. Specifically, the functions of the nanobubbles in the separation of the waste electronic equipment can be described in detail from the following aspects:
(1) Separation effect at high temperature: in the treatment process, waste electronic equipment is heated to a certain high temperature, which is beneficial to soften the injection-molding parts and adhesively bonded parts, such that they are more easily suffer from external force. The particle size of the nanobubbles is generally between several nanometers to several hundred nanometers. The nanobubbles have small particle sizes and low density, and show more active random motion at high temperatures. These high-speed moving nanobubbles continuously impact the surfaces of the injection-molding parts and the adhesively bonded parts, generating a mechanical force, thereby helping to destroy the structures of these materials and gradually loosen them.
(2) Generation of shock waves and action of hydroxyl radicals: during the impact process, the nanobubbles are broken due to over-stress. When the nanobubbles are broken, the gas in the nanobubbles is released rapidly to generate high-energy shock waves in a short time. These shock waves act on the injection-molding parts and the adhesively bonded parts, further destroying their structural and intermolecular bonding forces. Meanwhile, after the nanobubbles are broken, a large number of hydroxyl radicals (OH) with strong oxidizing properties are generated in the solution, such that organic molecules in the injection-molding parts and the adhesively bonded parts are oxidized to destroy chemical bonds of the organic molecules, particularly the connection among polymer chains, and further weaken the structural stability of the organic molecules.
(3) Effect of charged attraction: the nanobubbles can be made to carry specific charges (positive or negative) on their surfaces by adjusting the pH of the solution or adding a specific electrolyte. A large amount of the nanobubbles with specific charges will create a huge charged attraction in the solution. The attraction can attack the injection-molding parts and the adhesively bonded parts in a targeted manner, thereby effectively weakening the bonding force between them and the substrate.

In some implementations, the device to be treated may be crushed into small blocks and then placed in the nanobubble solution to be treated. In this way, the nanobubbles can act on the injection-molding parts and the adhesively bonded parts in the device more quickly and fully, thereby improving the effects of plastic removal and debonding. In some implementations, there is no limitation to the size and shape of the crushed parts, for example, the device to be treated may be cut into small blocks with the size of <10 cm*10 cm.

In some implementations, when heating is performed during immersing, the temperature may be greater than or equal to 180° C. In some implementations, for example, the temperature may be from 180° C. to 800° C., such as from 180° C. to 700° C., from 180° C. to 600° C., from 180° C. to 500° C., from 180° C. to 400° C., from 180° C. to 300° C., about 180° C., about 200° C., about 220° C., about 240° C., about 250° C., about 280° C., but is not limited to the listed values. Other non-listed values or ranges within the value range are equally applicable. It may be helpful to soften the injection-molding parts and adhesively bonded parts in the waste electronic equipment, such that they are more easily suffer from external force, thereby facilitating improvement of the effects of plastic removal and debonding.

In some implementations, when stirring is performed during the immersing, a rotating speed may be greater than or equal to 100 rpm. In some implementations, for example, the rotating speed of the stirring may be from 100 rpm to 2,000 rpm, such as from 200 rpm to 2,000 rpm, from 300 rpm to 2,000 rpm, from 400 rpm to 2,000 rpm, from 500 rpm to 2,000 rpm, from 500 rpm to 1,500 rpm, from 500 rpm to 1,000 rpm, from 500 rpm to 800 rpm, about 500 rpm, about 550 rpm, about 600 rpm, about 650 rpm, about 700 rpm, about 750 rpm, about 800 rpm, but is not limited to the listed values. Other non-listed values or ranges within the value range are equally applicable.

In some implementations, the time for immersing the device to be treated in the nanobubble solution may be greater than or equal to 1 h. In some implementations, for example, the time for immersing may be 1 h to 8 h, for example, 1 h, 2 h, 3 h, 4 h, 5 h, 6 h, 7 h, 8 h, but is not limited to the listed values. Other non-listed values or ranges within the value range are equally applicable.

In some implementations, after the immersing step, the solution may be filtered to obtain a plastic-removed and debonded waste device.

Compared with the prior art, the example techniques disclosed herein have the following beneficial effects:
1. Compared with the traditional method for recycling waste electronic equipment by applying a volatile nonpolar/polar solvent, the disclosed techniques use the nanobubble solution to recycle the waste electronic equipment, it is only needed for water, energy, and air, and there is no need to use the volatile nonpolar/polar solvent, thereby reducing the pollution to the environment and having good economic efficiency.
2. Compared with traditional cleaning of the waste electronic equipment, the method for cleaning by using the nanobubble solution provided by the disclosed techniques can realize the plastic removal and debonding of electronic products such as screen assemblies, Apple Cards, and Airpods only by one-step cleaning, and has a better cleaning effect. In addition, treatment in batches can be further performed, thereby greatly shortening the process route for recycling the waste electronic equipment.

### BRIEF DESCRIPTION OF THE DRAWINGS

FIG. 1 shows an example process route of the disclosed techniques;

FIG. 2 shows the Zeta potential of a nanobubble water solution in example 1;

FIG. 3 shows the distribution of the particle size of nanobubbles in example 1;

FIG. 4 shows the electronic wastes (a) before treatment and the electronic wastes (b) after the treatment in example 1;

FIG. 5 shows the electronic wastes (a) before treatment and the electronic wastes (b) after the treatment in comparative example 1;

FIG. 6 shows the electronic wastes (a) before treatment and the electronic wastes (b) after the treatment in comparative example 2;

FIG. 7 shows the electronic wastes (a) before treatment and the electronic wastes (b) after the treatment in example 2;

FIG. 8 shows the electronic wastes (a) before treatment and the electronic wastes (b) after the treatment in comparative example 3;

FIG. 9 shows the electronic wastes (a) before treatment and the electronic wastes (b) after the treatment in comparative example 4;

FIG. 10 shows the Zeta potential (a) before use and the Zeta potential (b) after use of a nanobubble water solution in example 3; and

FIG. 11 shows the electronic wastes (a) before treatment and the electronic wastes (b) after the treatment in example 3.

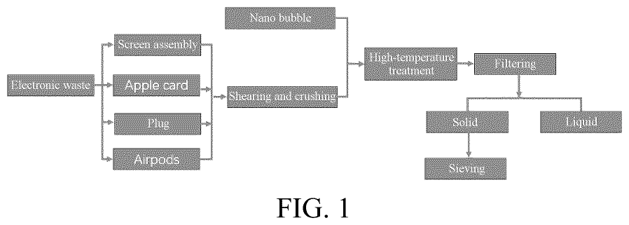

### DETAILED DESCRIPTION

The invention will be further described with reference to accompanying drawings and specific examples so as to enable the person skilled in the art to better understand the invention, while the illustrated examples are not intended to limit the invention.

Unless otherwise defined, all technical and scientific terms used herein have the same meaning as commonly understood by the person skilled in the field of the invention. The terms used in the description of the invention are only for the purpose of describing specific examples and are not intended to limit the invention. The term “and/or” used herein includes any combinations of one or more related listed items.

The experimental methods used in the following examples are conventional unless otherwise specified. The materials and reagents used are all commercially available unless otherwise specified.

### Example 1

This example provides a method for efficiently separating an injection-molding part/an adhesively bonded part by using a nanobubble water solution, comprising the following steps:
S1, according to the volume ratio of 1:200, an anionic surfactant was added into deionized water and sheared at a high speed of 10,000 rpm to obtain a nanobubble water solution with an average Zeta potential of −35 mV and the average particle size of 106.2 nm; and
S2, three pieces of waste electronic equipment positively charged on the surfaces, namely a screen assembly, an Apple Card, and an iPad metal rear cover were placed into the nanobubble water solution prepared in step S1, treated for three hours at a temperature of 200° C. and rotating speed of 500 rpm, and then filtered.

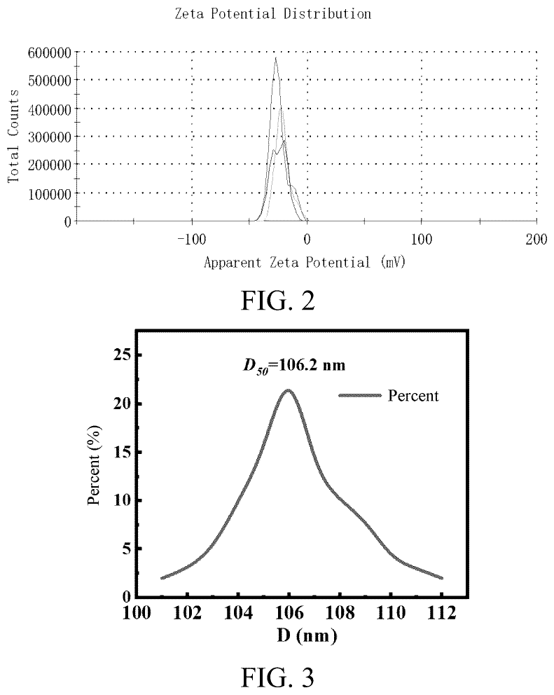

FIGS. 2 and 3 show the Zeta potential of the nanobubble water solution and the distribution of the particle size of nanobubbles in example 1, respectively. As shown in the figures, the average particle size of nanobubbles in the nanobubble water solution was 106.2 nm and the average Zeta potential of the nanobubble water solution was −35 mV.

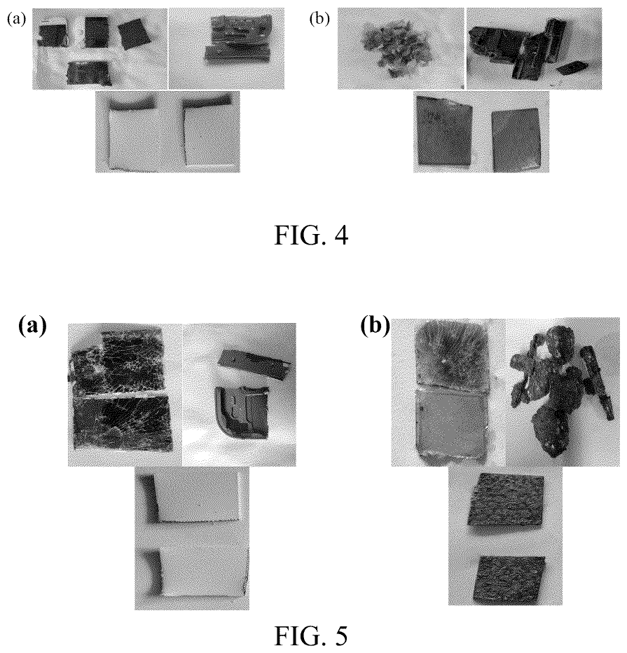

FIG. 4 shows the state of the waste electronic equipment before and after the treatment.

As shown in the figure, after the treatment with the nanobubble water solution, the plastic removal and debonding of the three pieces of electronic equipment positively charged on the surfaces were all realized and the efficient separation of plastics and a substrate was realized.

### Comparative Example 1

This comparative example provides a method for separating an injection-molding part/an adhesively bonded part by using a nanobubble water solution, comprising the following steps:
S1, according to the volume ratio of 1:200, a cationic surfactant was added into deionized water and sheared at a high speed of 10,000 rpm to obtain a nanobubble water solution with the average Zeta potential of +31 mV and the average particle size of 112 nm; and
S2, three pieces of waste electronic equipment positively charged on the surfaces, namely a screen assembly, an Apple Card, and an iPad metal rear cover were placed into the nanobubble water solution prepared in step S1, treated for three hours at a temperature of 200° C. and rotating speed of 500 rpm, and then filtered.

FIG. 5 shows the state of the waste electronic equipment before and after the treatment. As shown in the figure, the treatment by the nanobubble solution has a relatively poor effect on the plastic removal and debonding of a substrate positively charged on the surface.

The above results indicate that when the nanobubble solution and the waste electronic equipment are in the same charges (positive charges), the nanobubble solution has a poor treatment effect on the waste electronic equipment due to the repulsion between the same charges.

### Comparative Example 2

This comparative example provides a method for separating an injection-molding part/an adhesively bonded part by using a nanobubble water solution, comprising the following steps:
S1, according to the volume ratio of 1:200, an anionic surfactant was added into deionized water and sheared at a high speed of 500 rpm to obtain a nanobubble water solution with an average Zeta potential of −15 mV and an average particle size of 329 nm; and
S2, three pieces of waste electronic equipment positively charged on the surfaces, namely a screen assembly, an Apple Card, and an iPad metal rear cover were placed into the nanobubble water solution prepared in step S1, treated for three hours at a temperature of 200° C. and rotating speed of 500 rpm, and then filtered.

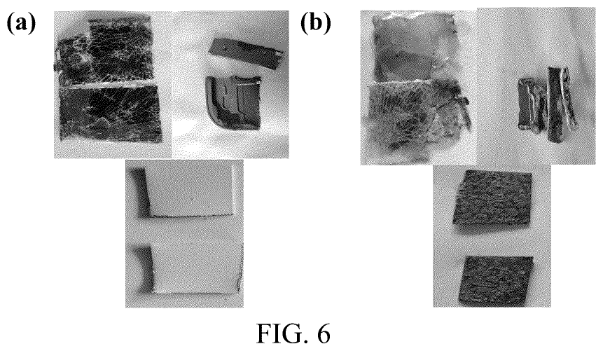

FIG. 6 shows the state of the waste electronic equipment before and after the treatment. As shown in the figure, the treatment by the nanobubble solution has a relatively poor effect on the plastic removal and debonding of the substrate.

The above results indicate that when the absolute value of the Zeta potential of the nanobubble solution is lower (<25 mV) and the average particle size is larger (>200 nm), nanobubbles have a smaller impact on plastic parts and adhesively bonded parts in the waste electronic equipment, thereby resulting in a poor treatment effect on the waste electronic equipment.

### Example 2

This example provides a method for efficiently separating an injection-molding part/an adhesively bonded part by using a nanobubble water solution, comprising the following steps:
S1, according to the volume ratio of 1:200, a cationic surfactant was added into deionized water and sheared at a high speed of 10000 rpm to obtain a nanobubble water solution with an average Zeta potential of +31 mV and an average particle size of 112 nm; and
S2, two pieces of waste electronic equipment negatively charged on the surfaces, namely Airpods and a charger plug were placed into the nanobubble water solution prepared in step S1, treated for three hours at a temperature of 200° C. and rotating speed of 500 rpm, and then filtered.

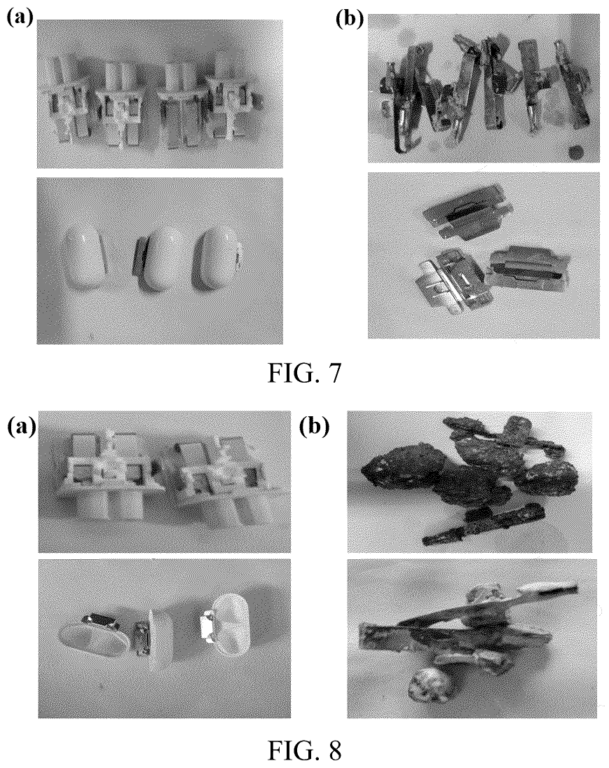

FIG. 7 shows the state of the two pieces of waste electronic equipment before and after the treatment. As shown in the figure, it achieves good plastic removal and debonding for the two pieces of waste electronic equipment negatively charged on the surfaces.

### Comparative Example 3

This comparative example provided a method for separating an injection-molding part/an adhesively bonded part by using a nanobubble water solution, comprising the following steps:
S1, according to the volume ratio of 1:200, a cationic surfactant was added into deionized water and sheared at a high speed of 500 rpm to obtain a nanobubble water solution with an average Zeta potential of +15 mV and the average particle size of 329 nm; and
S2, two pieces of waste electronic equipment negatively charged on the surfaces, namely Airpods and a charger plug were placed into the nanobubble water solution prepared in step S1, treated for three hours at a temperature of 200° C. and rotating speed of 500 rpm, and then filtered.

FIG. 8 shows the state of the two pieces of waste electronic equipment before and after the treatment. As shown in the figure, the nanobubble solution has a relatively poor effect on the plastic removal and debonding of the substrate.

The above results indicate that when the absolute value of the Zeta potential of the nanobubble solution is lower (<25 mV) and the average particle size is larger (>200 nm), nanobubbles have a smaller impact on plastic parts and adhesively bonded parts in the waste electronic equipment, thereby resulting in a poor treatment effect on the waste electronic equipment.

### Comparative Example 4

This comparative example provides a method for separating an injection-molding part/an adhesively bonded part by using a nanobubble water solution, comprising the following steps:
S1, according to the volume ratio of 1:200, an anionic surfactant was added into deionized water and sheared at a high speed of 10,000 rpm to obtain a nanobubble water solution with an average Zeta potential of −35 mV and the average particle size of 106.2 nm; and
S2, two pieces of waste electronic equipment negatively charged on the surfaces, namely Airpods and a charger plug were placed into the nanobubble water solution prepared in step S1, treated for three hours at a temperature of 200° C. and rotating speed of 500 rpm, and then filtered.

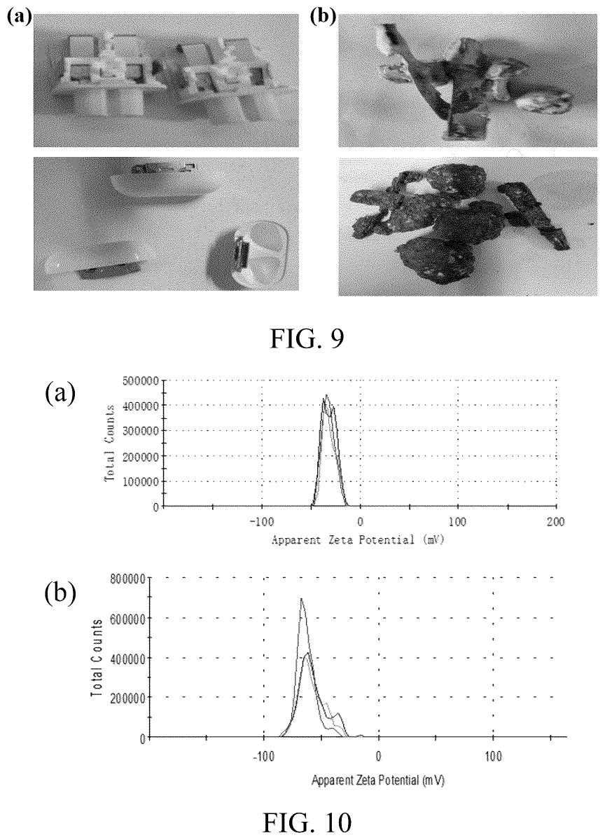

FIG. 9 shows the state of the two pieces of waste electronic equipment before and after the treatment. As shown in the figure, the nanobubble solution has a relatively poor effect on the plastic removal and debonding of a substrate negatively charged on the surface.

The above results indicate that when the nanobubble solution and the waste electronic equipment are in the same charges (negative charges), the nanobubble solution has a poor treatment effect on the waste electronic equipment due to the repulsion between the same charges.

### Example 3

To verify the cycling stability of the nanobubble water solution, after the nanobubble solution was filtered when the one separation in example 1 was finished, the nanobubble solution was used to treat three pieces of waste electronic equipment positively charged on the surfaces, namely a screen assembly, an Apple Card, an iPad metal rear cover, again for three hours at a temperature of 200° C. and rotating speed of 500 rpm, and then filtered.

FIG. 10 shows the Zeta potential of the nanobubble water solution before and after the treatment. As shown in the figure, after the waste electronic equipment was treated with the nanobubble solution, the absolute value of the Zeta potential was rather large.

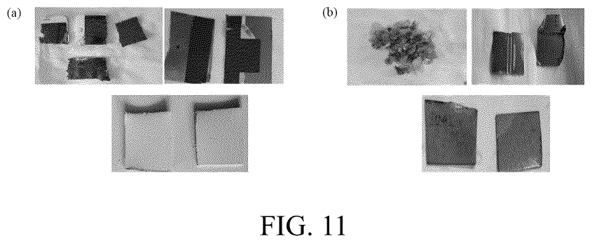

FIG. 11 shows the state of the waste electronic equipment before and after the treatment. As shown in the figure, after the waste electronic equipment is treated with the nanobubble solution, the nanobubble solution still has a good separation effect and good cycling stability.

The aforementioned examples are only preferred examples illustrated for fully explaining the invention, and the protection scope of the invention is not limited thereto. Equivalent substitutions or modifications made by the person skilled in the art on the basis of the invention are within the scope of the invention. The scope of the invention shall be determined by the claims.

What is claimed is:

1. Use of a nanobubble solution for separating an injection-molding part/an adhesively bonded part.

2. The use according to claim 1, wherein an absolute value of the Zeta potential of the nanobubble solution is greater than or equal to 25 mV, and an average particle size of nanobubbles in the nanobubble solution is less than or equal to 200 nm.

3. The use according to claim 1, wherein the nanobubble solution is a water solution or an aqueous solution incorporated with nanobubbles; and/or
gas in the nanobubbles comprises at least one of air, nitrogen, oxygen, ozone, carbon dioxide, nitrogen dioxide, nitric oxide, and inert gas.

4. Use of a nanobubble solution for recycling waste electronic equipment.

5. The use according to claim 4, wherein an absolute value of the Zeta potential of the nanobubble solution is greater than or equal to 25 mV, and an average particle size of nanobubbles in the nanobubble solution is less than or equal to 200 nm.

6. The use according to claim 4, wherein the nanobubble solution is a water solution or an aqueous solution incorporated with nanobubbles; and/or
gas in the nanobubbles comprises at least one of air, nitrogen, oxygen, ozone, carbon dioxide, nitrogen dioxide, nitric oxide, and inert gas.

7. A method for separating an injection-molding part/an adhesively bonded part by using a nanobubble solution, comprising
immersing a device to be treated in the nanobubble solution while heating and stirring,
wherein the device to be treated and the nanobubble solution is oppositely charged, an absolute value of the Zeta potential of the nanobubble solution is greater than or equal to 25 mV, and an average particle size of nanobubbles in the nanobubble solution is less than or equal to 200 nm.

8. The method for separating an injection-molding part/an adhesively bonded part by using a nanobubble solution according to claim 7, wherein the device comprises waste electronic equipment; and/or
before immersing the device in the nanobubble solution, the device is broken into small blocks; and the size of the small blocks is less than or equal to 10 cm*10 cm.

9. The method for separating an injection-molding part/an adhesively bonded part by using a nanobubble solution according to claim 7, wherein the nanobubble solution is a water solution or an aqueous solution incorporated with nanobubbles; and/or
gas in the nanobubbles comprises at least one of air, nitrogen, oxygen, ozone, carbon dioxide, nitrogen dioxide, nitric oxide, and inert gas.

10. The method for separating an injection-molding part/an adhesively bonded part by using a nanobubble solution according to claim 7, wherein the heating is performed at a temperature of 180° C.-800° C.

11. The method for separating an injection-molding part/an adhesively bonded part by using a nanobubble solution according to claim 7, wherein the device is immersed for 1-8 h.

12. The method for separating an injection-molding part/an adhesively bonded part by using a nanobubble solution according to claim 7, further comprising filtering to obtain a plastic-removed and debonded waste device after the immersing step.
